(19) United States
(12) Patent Application Publication
(10) Pub. No.: US 2005/0234999 A1
(43) Pub. Date: Oct. 20, 2005

(54) Method and apparatus for providing a playlist in a compact disc player

(76) Inventors: Thomas N. Millikan, Austin, TX (US); Charles E. McCallum, Dallas, TX (US)

Correspondence Address: TEXAS INSTRUMENTS INCORPORATED, P O BOX 655474, M/S 3999, DALLAS, TX, 75265, US

(21) Appl. No.: 11/156,963

(22) Filed: Jun. 20, 2005

Related U.S. Application Data
(62) Division of application No. 10/202,349, filed on Jul. 24, 2002.
(60) Provisional application No. 60/325,309, filed on Sep. 27, 2001.

(51) Int. Cl. G06F 17/30

(52) U.S. Cl. 707/104.1

(57) ABSTRACT

A method and apparatus for placing a playlist in a memory location on a compact disc is disclosed. The user reviews the audio files located on the CD, selects the songs that will be included in the playlist, determines the sequence or order of playback for those selected audio files, and places the playlist in a selected memory location such as the CD, or the local memory of the CD player. The user may then access the playlist and playback audio files in accordance with the playlist.

### BACKGROUND OF THE INVENTION

A compact disc may be formatted to include compressed audio content, such as MP3 files, Ogg Vorbis files, or any other suitable compressed audio format. Modem audio compression algorithms allow users to store dozens, or even hundreds, of music files or songs on a single CD. In the case of the MP3 compressed audio format, as many as 400 music files or songs can be placed on a single compressed audio CD. A CD that includes compressed audio files can be played on a CD player that is configured for the playback of compressed audio files formatted on a CD disc. CD players of this sort include CD-ROM players and hybrid CD players that can play both traditional CDs and CD-ROMs that include compressed audio files. Regardless of the particular compact disc format, CDs that includes compressed audio files are referred to herein as compressed audio CDs.

Users typically store their music files on the basis of artist and album. However, users frequently wish to playback their files in a more complex manner. For example, users may wish to play a selection of several songs based on genre, style, theme or their own response to certain songs. However, because of the sheer number of files that may be placed on a compressed audio CD, users may find it difficult to organize and access the large collection of music that is stored on these CDs. For example, CD players often use small LCDs for file feedback and file navigation. While these small displays are sufficient for uncompressed audio CDs, a user will be unable to access music in a timely and orderly fashion for compressed audio CDs that contain hundreds of files. For instance, a user typically has to scroll through the entire collection, track by track, to find the song or file that the user is interested in playing. This problem is exacerbated for portable CD players, because the controls and displays tend to be smaller than those of console CD players and the user is typically mobile or otherwise preoccupied. As a result, users are generally relegated to listening to their music in the seemingly random order in which the files were written to the compressed audio CD.

### SUMMARY OF THE INVENTION

Accordingly, a need has arisen for a method and apparatus for allowing users to organize a large collection of audio files placed on a compact disc and to play those audio files in a predetermined manner that does not cause unreasonable delay or inconvenience. In accordance with the teachings of the present invention, a method and apparatus for allowing a user to organize and playback audio files stored on a CD player is provided that substantially eliminates or reduces the disadvantages and problems associated with prior techniques.

According to one embodiment of the present invention, a method and apparatus for placing a playlist on a CD is disclosed, that greatly facilitates a user's ability to navigate through large numbers of files on the CD. The user reviews the audio files located on the CD, selects the songs that will be included in the playlist, determines the sequence or order of playback for those selected audio files, and places the playlist in a selected memory location on the CD.

An important technical advantage of the present invention is that a playlist may be associated with a compressed audio CD that may contain hundreds of files across several directories. Instead of searching through multiple files and directories, the technique of the present invention allows the user to quickly play selected songs in a selected manner, rather than in the seemingly random order in which the files were written to the CD. Another advantage of the present invention is that the playlist is not limited by the memory buffer of the CD player. Accordingly, the number of playlists that the user may associated with the CD is limited by the storage capacity of the CD rather than the memory of the CD player. Multiple playlists may be written to the CD to allow the user greater flexibility in organizing and managing the audio files on the CD. In addition, the playlist is not erased when the CD is removed from the CD player. Furthermore, the CD playlists may contain other playlists and may be more complex than those playlists stored in the memory of a CD player.

Another important technical advantage of the present system is that the playlist is relatively simple to create and is not inherent to any particular file system structure. As a result, the playlist may be implemented by electronic devices with limited memory and processing. Accordingly, the present system is well suited for portable CD players.

### BRIEF DESCRIPTION OF THE DRAWINGS

A more complete understanding of the present invention may be acquired by referring to the accompanying figures in which like reference numbers indicate like features and wherein:

FIG. 1 is a graphical depiction of the logical structure of the file system of a compressed audio compact disc;

FIG. 2 is a functional block diagram of a digital signal processor and memory of a CD player that is configured to play compressed audio files;

FIG. 3 is a functional block diagram of a digital signal processor and memory of a CD writer that is configured to write files to a recordable CD;

FIG. 4 is a flow diagram of a method for reading a playlist from a compressed audio CD with the technique of the present invention;

FIG. 5 is a flow diagram of a method for creating a playlist for a compressed audio CD with the technique of the present invention; and

FIG. 6 is a flow diagram of a method for creating a playlist that is comprised of other playlists.

### DETAILED DESCRIPTION OF THE INVENTION

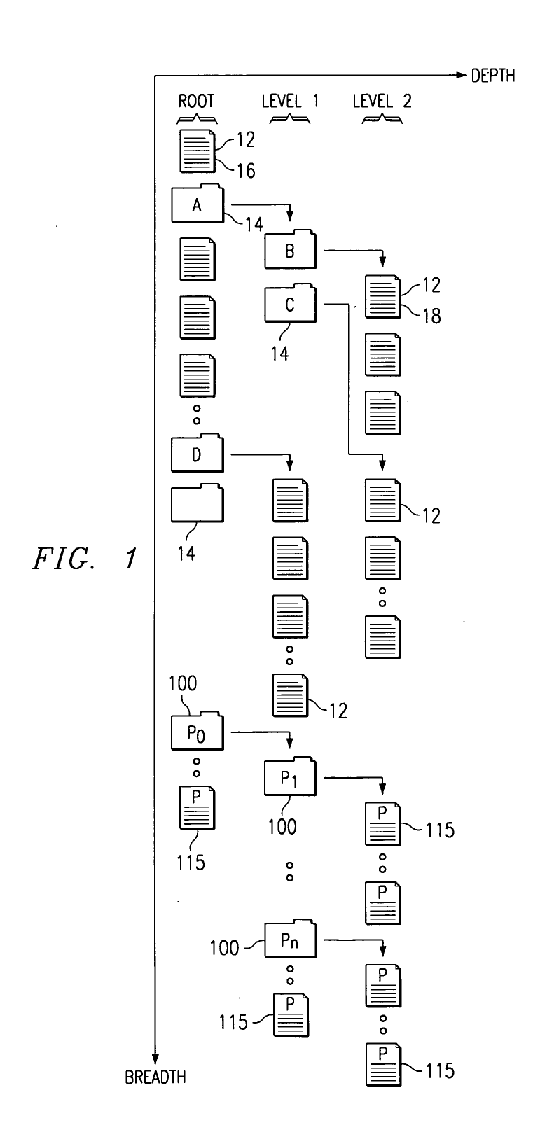

Shown in FIG. 1 is a graphical depiction of the logical structure of the file system of a compressed audio compact disc. Conventional audio CDs do not include a file system. Instead, conventional audio CDs include directory information that is arranged sequentially on the CD. In contrast, the file system of a CD that includes compressed audio files is somewhat detailed and is arranged logically in the form of a tree data structure, as shown in FIG. 1. The tree data structure of a compressed audio CD includes a root directory. A number of files or file folders can be placed on the root directory, with each file folder comprising a directory for a number of other files and file folders. The folders of the directory tree of the CD can be used to group individual files or songs on the basis of the artist of the selection, the album of the song or musical selection, or the type of song or music selection. This file system may be arranged according to the preferences of the user and may be unique to each CD to be played by the CD player.

The files of the file system are generally indicated by icons 12 and the folders of the file system are generally indicated by icons 14. A number of files 12 and folders 14 are at the root level of the file system. Files 12 may be compressed audio files or tracks, such as MP3 or Ogg Vorbis files. The contents of folder A are folder B and folder C, which are shown at Level 1 of the file system. Folder B, in turn, includes three music files 12, and Folder C also includes a number of music files 12. Folder A may represent an artist, for example, and Folders B and C may represent albums of the artist, with the individual selections from the albums of the artist included as files in Level 2. The other files of the root level and level 1 may be compressed audio files for other artists. An entry for a file in the directory of a CD includes identifying information concerning the name of the file, the location of the file content on the CD, and the length of the file content on the CD. An entry for a folder in the directory of the CD includes identifying information concerning the name of the folder and a pointer to a second location on the CD that includes an identification of the contents of the folder.

The file system also contains a playlist file 115. The playlist file 115 may be located in the root directory of the file structure. Playlist 115 may be a list, table, array, or similar data structure or file that prescribes a selection of files 12 and the manner in which these selected files are to be accessed or played. For example, playlist 115 may be a simple text or binary file that contains a list of files 12 to be played and an order in which the files should be played. Playlist 115 also contains information regarding the file path or location in the file tree of each selected audio file. For instance, Folders B, C and D may contain tracks from a different albums or artists. Playlist 115 may be a list of selected files 12 from Folders A through D, and the sequence in which these selected files 12 are to be played. The user play songs from Folders B, C, and D according to playlist 115, rather than by the process of scrolling through the entire collection and individually selecting the songs.

By using playlist 115, a user may organize the music in any manner that the user prefers. For example, the user may select songs across several separate folders 14 that evoke a certain reaction, i.e. “romantic songs,” or that are suitable for a particular activity such as an exercise routine, i.e. jogging, or according to a genre, i.e. “easy-listening jazz.” The file structure may also contain a playlist folder 100. Playlist folder 100 may be placed in the root directory of the file structure. The contents of a playlist folder 100 may be playlist files 115 or other playlist folders 100 that are organized as subfolders. The user may organize several playlists 115 using playlist folders 100.

The file system of a compressed audio CD can be described as having both depth and breadth. The depth of the file system is characterized by the existence or the number of nested file folders within any of the file folders of the file system. The breadth of a file system is characterized by the number of file and file folders existing at the root directory level or within any other file folder of the file system. A CD player that is configured to play compressed audio CDs uses the file system data on the CD to build a file tree that is stored in the CD player. The file tree is built by reading each file or folder in the file system according to a depth first or a breadth first searching scheme.

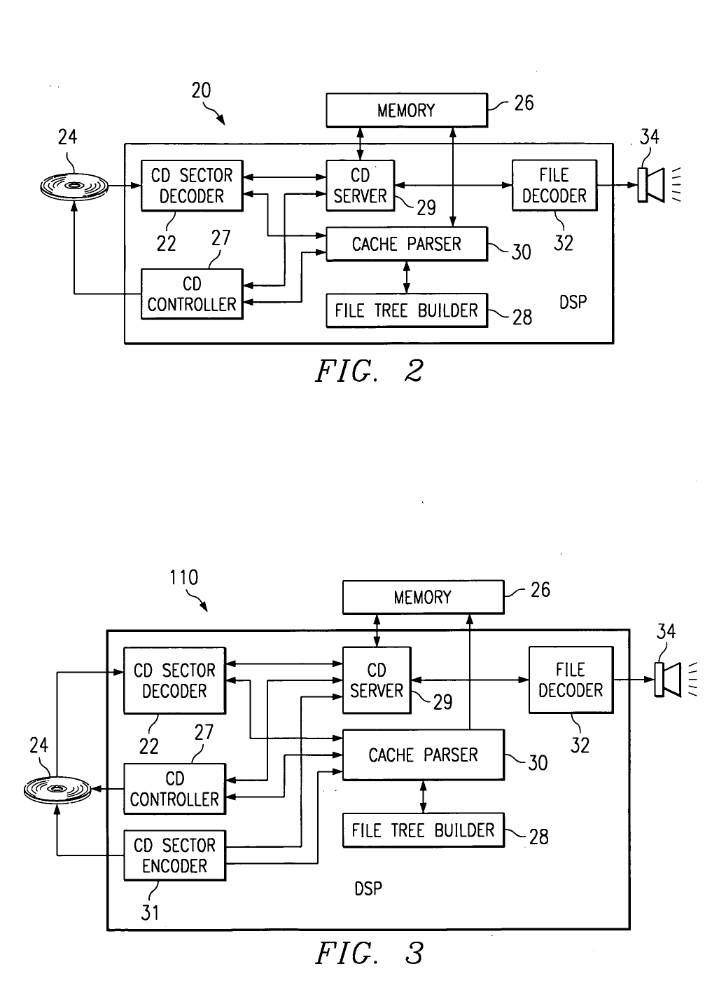

Shown in FIG. 2 is a functional block diagram of a digital signal processor (DSP) and memory of a CD player, which is indicated generally at 20 and that is configured to play compressed audio files in accordance with a playlist 115 stored on a CD. A CD sector decoder 22 retrieves sectors from CD 24. After retrieving a sector or sectors from CD 24, CD sector decoder 22 performs an error correction routine on the data and stores the data in memory 26, which may be dynamic RAM. The file tree builder 28 determines the searching scheme for the build of the file tree and also identifies the target sector for the build of the file tree. The term target sector refers to the sector on the CD 24 whose data is currently necessary for the build of the file tree. CD player 20 may also contain a cache parser 30 to facilitate the build of the file tree. If CD player 20 contains a cache parser, then the file tree builder 28 identifies the target sector to the cache parser 30. Before sending a retrieve instruction to CD controller 27, cache parser 30 determines if the target sector is in memory 26. At the completion of the file tree building, the file tree is passed for storage to memory 26. As part of the playback of audio, data is retrieved from memory 26 by CD server 29, which passes the data to format decoder 32. File decoder 32 processes the compressed audio data before transmission of the uncompressed audio stream to speaker system 34. The operation of file decoder 32 depends on the compression format of audio files 12 present on CD 24. For example, if CD player 20 is intended to play MP3 files, file decoder 32 may be a MP3 decoder. CD player 20 is enabled to parse playlist files 115 and access the audio files 12 stored on CD 24 accordingly. The CD player 20 may also incorporate controls for creating a playlist 115. For example, the user may activate a playlist creation function on the CD, navigate through the audio files using the CD player's navigation controls, select audio files for inclusion in the playlist, and then write the playlist to a CD 24 or memory 26 when the playlist is complete.

Shown in FIG. 3 is a functional block diagram of a DSP and memory of a CD writer, which is indicated generally at 110 and that is configured to write files to a CD, including a playlist 115 and compressed audio files 12. The CD writer generally contains the same functional components as the CD player shown in FIG. 2 and discussed above. The CD writer also contains a CD sector encoder 31 that is connected to the cache parser 28 and CD server 29. The CD sector encoder 31 interacts with CD 24 to write encoded information to CD 24. For example, the CD sector encoder 31 may direct a write laser to alter to surface of CD 24 in order to store information on CD 24. The CD sector encoder may write the files in any desired file structure. For example the CD sector encoder 31 may write the files to the root directory or to folders 14. Accordingly, the CD writer shown in FIG. 3 is operable to write one or more playlists 115 directly to CD 24 corresponding to the audio files stored on CD 24.

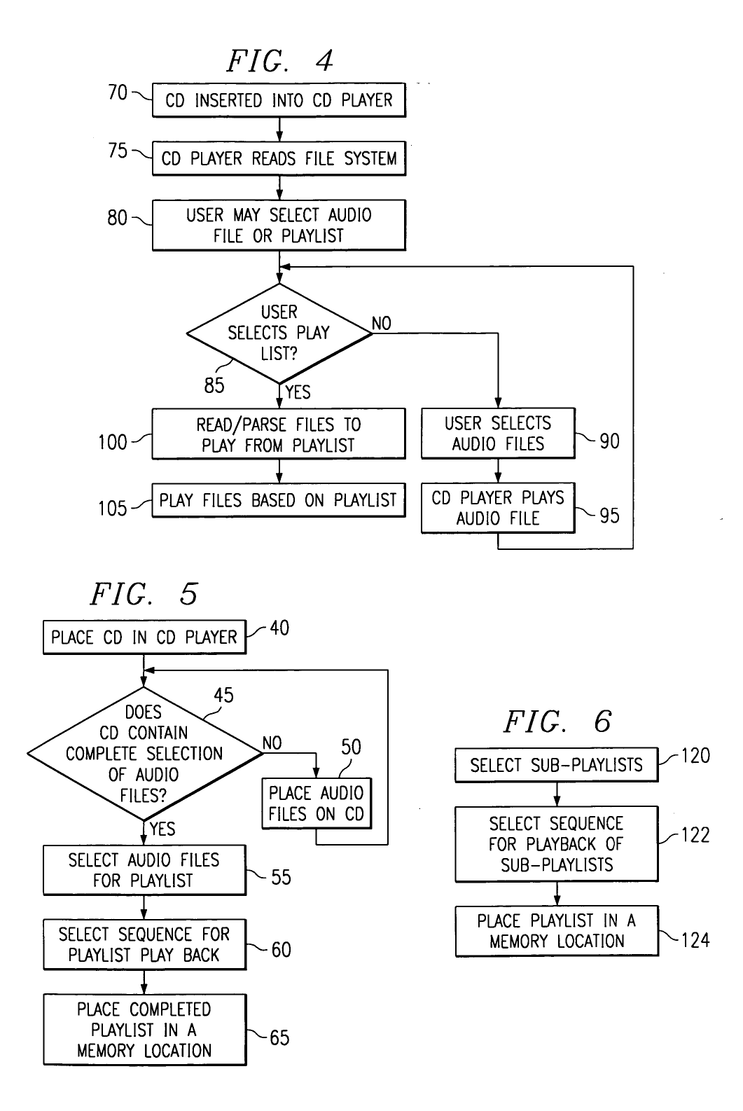

Shown in FIG. 4 is a flow diagram for playing files in accordance with a playlist 115 for a CD with the technique of the present invention. At step 70, the user inserts the CD into the CD player. At step 75, the CD player reads the file system or file tree of the CD. Once the file system has been constructed, the user may then access the files or directories stored on the CD at step 80. Accordingly, at step 85, the user may then select an audio file 12 to play or select a playlist 115 to playback several audio files 12 in a predetermined manner. If the user elects to play an audio file at step 90, then the CD player may subsequently initiate the playback of the selected audio file 12 at step 95. If the user selects a playlist 115 at step 85, then the CD player reads or parses the file structure of the CD in order to play the files listed on the playlist. As discussed above, the audio files 12 listed in the selected playlist 115 may be located in several separate directories 14. The selected playlist 115 may contain one or more playlists 115. For example, a playlist for a general category of music, i.e. “dance” music, may include several playlists corresponding to more specific genres of music, i.e. “disco” music and “club” music. Accordingly, the CD player plays the files 12 based on the playlist 115, at step 105. The CD player may store the file information from the playlist 115 in memory 26 to facilitate playing the audio files.

Shown in FIG. 5 is a flow diagram for creating a playlist 115 for a CD with according to the method for a present invention. At step 40, the user places the CD in a CD player that is able to record, encode, or bum a file to a CD. For example, the CD player described with respect to FIG. 5 may include any CD-ROM players and hybrid CD players that have a write capability and can play both traditional CDs and CD-ROMs that include compressed audio files. At step 45, the user determines whether the CD contains all of the audio files that the user wishes to place on this CD. If not, the user continues to select audio files for placement on the CD at step 50. These additional audio files may be stored on another memory location such as another CD or a computer system storage device. When the user is satisfied that the CD contains the complete selection of audio files 12, the user selects those audio files 12 that will be included in the playlist 115 at step 55. The user also selects the sequence in which those selected audio files 12 will be played at step 65. Once the playlist has been completed, the user places the completed playlist 115 in a memory location at step 65. For example, the user may wish to place the playlist 115 on the CD. In this case, the CD player may burn the playlist 115 onto the CD. The user may place the playlist 115 in any desired location in the file tree of the CD. For example, the user may place the playlist 115 in the root directory, or in a folder 100. Alternatively, the user may place the playlist in the memory 26 of the CD player.

If a CD includes a number of playlists 115, the user may choose to create a playlist that is itself a grouping of playlists. Shown in FIG. 6 is a method for creating a playlist that is a grouping of other playlists on the same CD. At step 120, the user selects a number of playlists for playback. Because these playlists will be used to prepare a subsequent playlist, the selected playlists will be referred to as sub-playlists. At step 122, the user selects the order of playback for the selected playlists. The ordered playback of selected sub-playlists comprises its own playlist. At step 124, the newly created playlist may be saved to a memory location, such as the CD itself or in the memory of the CD player. As such, a playlist may include both individual audio files and other playlists. A playlist may be a hybrid of both individual files and other playlists.

The present invention is advantageous in that the technique disclosed herein allows a user to include a playlist in the file system of a CD. Playlists allow the user to conveniently organize a large directory of audio files and playback selected audio files in any desired manner. As a result, a user need not scroll through an entire directory that may contain dozens or hundreds of files located across several folders in order to playback selected audio files in a particular sequence. Furthermore, a user may organize the audio files according to genre, style, theme, activity or any other manner, instead of being limited to the order in which the files were burned onto the CD. The present technique is particularly advantageous for portable CD players for which file navigation is inconvenient and impractical

Although this invention has been described with reference to the MP3 and Ogg Vorbis data format, it should be understood that the invention may be employed with any other compressed audio format. Although the present invention has been described in detail, it should be understood that various alterations, changes, modifications, and substitutions may be made to the teachings described herein without departing from the scope of the present invention, which is solely defined by the appended claims.

1-10. (canceled)

11. A method for playing audio files on a CD, wherein the CD comprises a file system, comprising the steps of:
reading the file system of the CD;
selecting a playlist located on a CD, wherein the playlist defines the sequence of playback for a plurality files contained in the playlist and located on the CD;
parsing the files defined in the playlist; and
initiating the playback of the files in accordance with the playlist.

12. The method of claim 11, wherein the playlist comprises a list of audio files.

13. The method of claim 11, wherein the playlist comprises a second playlist.

14. A CD player operable to play compressed audio files on a CD in accordance with a playlist stored in a memory location on the CD;
a CD sector decoder for retrieving sectors from a CD;
a memory coupled to the CD sector decoder for storing sectors retrieved from the CD;
a cache parser coupled to the CD sector decoder and memory; and
a file tree builder coupled to the cache parser;
wherein the CD player is operable to parse through the playlist and play audio files in accordance with the playlist.

15. The CD player of claim 14, wherein the playlist comprises a list of audio files.

16. The CD player of claim 14, wherein the playlist comprises a second playlist.

17. The CD player of claim 14, further comprising a sector encoder operable to write the playlist to a memory location on the CD.

18. The CD writer of claim 17, further comprising an interface operable to allow the user to add a plurality of entries to the playlist and assign a sequence for playback for those entries.

19 to 21. (canceled)
